(19) United States
(12) Patent Application Publication
(10) Pub. No.: US 2002/0082851 A1
(43) Pub. Date: Jun. 27, 2002

(54) Ambulatory arrythmia system investment planning method and apparatus

(76) Inventor: Vincent E. Majkowski, Milwaukee, WI (US)

Correspondence Address: Patrick S. Yoder, Suite 330, 7915 FM 1960 West, Houston, TX, 77070, US

(21) Appl. No.: 09/747,540

(22) Filed: Dec. 22, 2000

(51) Int. Cl. G06F 17/60

(52) U.S. Cl. 705/1

(57) ABSTRACT

A system and method for providing an ambulatory monitoring (AM) system customer with a recommended AM system. The recommended AM system being established by a customer's responses to a plurality of questions provided to the customer over a network via a query page. The system having a product selector file and a product configuration file. The product selector file provides the query page with the plurality of questions to be answered by the customer. The product configuration file having a plurality of AM systems associated with specific responses to the questions on the query page. A Java applet being used to compare the customer's responses to the plurality of questions to the information in the product configuration file. The product configuration file supplying a results page with the recommended system based on the customer's responses to the questions on the query page. The system providing the results page to the customer over the network.

### FIELD OF THE INVENTION

The present invention relates generally to a method and apparatus for providing purchasing information to an ambulatory monitoring (AM) system customer, and more particularly, to a method and apparatus to enable an AM system supplier to provide a customer with a recommended an AM system.

### BACKGROUND OF THE INVENTION

Electrocardiograph (ECG) analysis is a well-established method for studying the function of the heart and identifying disorders of the heart. ECG analysis provides graphical information that can indicate abnormalities in the heart such as irregular heart rates or rhythms, or abnormal conduction pathways. Likewise, an ECG can indicate the location of damaged cardiac tissues if it exists. Perhaps best of all, the ECG allows a physician to diagnose abnormalities inexpensively, without using surgical procedures An ECG is a graphic tracing of the variations and the electrical potential caused by the excitation of the heart muscle as detected at the body surface by leads of the ECG device. A normal electrocardiogram is a scale or representation that shows deflections resulting from cardiac activity as changes in the magnitude of voltage and polarity over time and includes a P-Wave, a QRS complex, and a T-Wave. The P-Wave is due to atrial contraction and is known as the atrial complex. The Q, R S, and T deflections are all due to the action of the ventricles and are known as the ventricular complexes. These waves are then analyzed using a set of rules and parameters to determine what is normal and what is not. Certain deviations are used to flag possible complications.

ECG examinations may be performed as the patient is experiencing different levels of heart stress. For example, ECG examinations may be performed while the patient has a high level of heart activity, such as during vigorous exercise, or at a lower level of activity, such as during a resting period. The different levels of heart activity provide different windows into the operation of the patient's heart. A patient may also experience intermittent cardiac conditions.

Ambulatory electrocardiography, also called Holter monitoring, is one method of monitoring intermittent cardiac conditions with an ECG. In ambulatory cardiography, the patient wears a small recorder, called a Holter monitor, which records the electric currents generated by the heart. while the patient is walking or moving around. The main goal of ambulatory cardiography is to document and describe occurrences of abnormal electrical behavior in the heart. These can be random, spontaneous, sleep-related, emotion or stressed induced. These events are often rare and sometimes can be life-threatening. To capture these events and correlate the symptoms with heart rhythmic disturbances during activity requires recoding or observing the heart's electrical behavior. This may need to be done continuously over a prolonged period of time as the person goes through their normal day to day activities.

Many recording devices have been developed to perform ambulatory electrocardiography. They fall into a variety of models. Some are recorders that record continuously for, typically, 24-48 hours. Other recorders are intermittent recorders that only record intermittently, for example when prompted by the patient developing the particular abnormal symptoms. These recorders may record for weeks, even months.

To purchase an ambulatory monitoring (AM) system, a customer may contact a supplier of AM systems to request information regarding the supplier's AM systems. Alternatively, an AM system supplier may contact a customer in hopes of generating sales of AM systems. Both parties in each of these cases may waste significant amounts of time attempting to elicit basic information from the other. For example, it may take an AM system supplier a significant amount of time to establish the customer's basic AM system needs or desires. Additionally, a customer may expend significant amounts of time obtaining basic information about the AM systems available from the supplier. Indeed, the customer may receive information about AM systems that are simply not suited for the customer's needs.

There is a need, therefore, for an improved technique for providing an AM system customer with purchasing information regarding a supplier's AM systems prior to contact between a sales representative of the supplier and the customer. There is a particular need for a system or method that provides a customer with information for a recommended AM system in response to a customer query designed to provide the supplier with some basic information bout a customer's needs for an AM system.

### SUMMARY OF THE INVENTION

According to one aspect of the present invention, a system is featured. The system is coupled to a network to enable an ambulatory monitoring (AM) system supplier provide a customer with a recommended AM system. The system comprises an application server, a comparison program and a server. The application server directs a query page to the customer via the network. The query page has a plurality of questions and a plurality of answer choices for each question. A customer's answers to the questions enable the system to determine a recommended AM system. At least one question is designed to determine what type of data recorder the customer is to use with the AM system. The system also comprises a comparison program to receive a completed query page containing the customer's answers to the questions. The comparison program compares the customer's answers to information stored in the computer system that relates the customer's answers to specific AM systems. The specific AM that corresponds to a customer's answers being the recommended AM system. The system also comprises a server to provide a results page to the customer via the network. The results page provides the customer with the recommended AM system.

According to another aspect of the present invention, a computer system is featured. The computer system is coupled to a network to enable an AM system supplier to provide a customer with a recommended AM system over the network. The computer system comprises an application server, a product selector file, a program, and a product configuration file. The application server is coupled to a network. The application server directs a customer from the network to files stored in the computer system. The product selector file is written in a markup language and stored in the computer system. The product selector file holds a plurality of questions designed to obtain data from a customer to determine a AM system, from among a plurality of AM systems, to recommend to the customer. The product selector file provides the plurality of questions to a query page for delivery to a customer. The program operates to determine a recommended AM system for the customer by comparing data provided by the customer via the plurality of questions to AM system data stored in the computer system. The product configuration file is written in a markup language and stored in the computer system. The product configuration file holds the AM system data used by the program. The product configuration file also provides the recommended AM system to a results page for delivery to the customer.

According to another aspect of the present invention, a method is featured of utilizing a computer system coupled to a network to assist a customer to configure an AM system. The method enables a supplier to recommend a AM system to the customer from among a plurality of AM systems, components and software. The method comprising the act of routing a request for assistance from a customer to a product selector file written in extensible markup language (XML). The product selector file fills a template with questions stored in the product selector file. The method also comprises the acts of delivering the template over the network to a customer and receiving a completed template from the customer. The method also comprises the act of determining a recommended AM system configuration by comparing customer data derived from the completed template to supplier data stored in the computer system in a product configuration file written in XML. The product configuration file fills a results page with the recommended AM system configuration for delivery to the customer over the network.

### BRIEF DESCRIPTION OF THE DRAWINGS

FIG. 1 is a visual representation of the operation of an ambulatory monitoring (AM) system;

FIG. 2 is a list of questions for use in a product selector for an AM system;

FIG. 3 is a template of AM systems corresponding to predicted answers to the question of FIG. 2;

FIG. 4 is a diagrammatical representation of a computer system to enable an AM system supplier to provide a customer with a recommendation for an AM system;

FIG. 5 is a flowchart for a process whereby an AM system supplier may provide a customer with a recommendation for an AM system;

FIG. 6 is a representation of a page for an ECG system supplier, the page having a link to an AM system product selector;

FIG. 7 is a representation of a query page for an AM system product selector;

FIG. 8 is a representation of a help page for an AM system product selector;

FIG. 9 is a representation of a results page featuring a recommended AM system; and

FIG. 10 is a representation of a results page when the system cannot provide a recommended AM system and directing the customer to contact a supplier's representative.

### DETAILED DESCRIPTION OF THE INVENTION

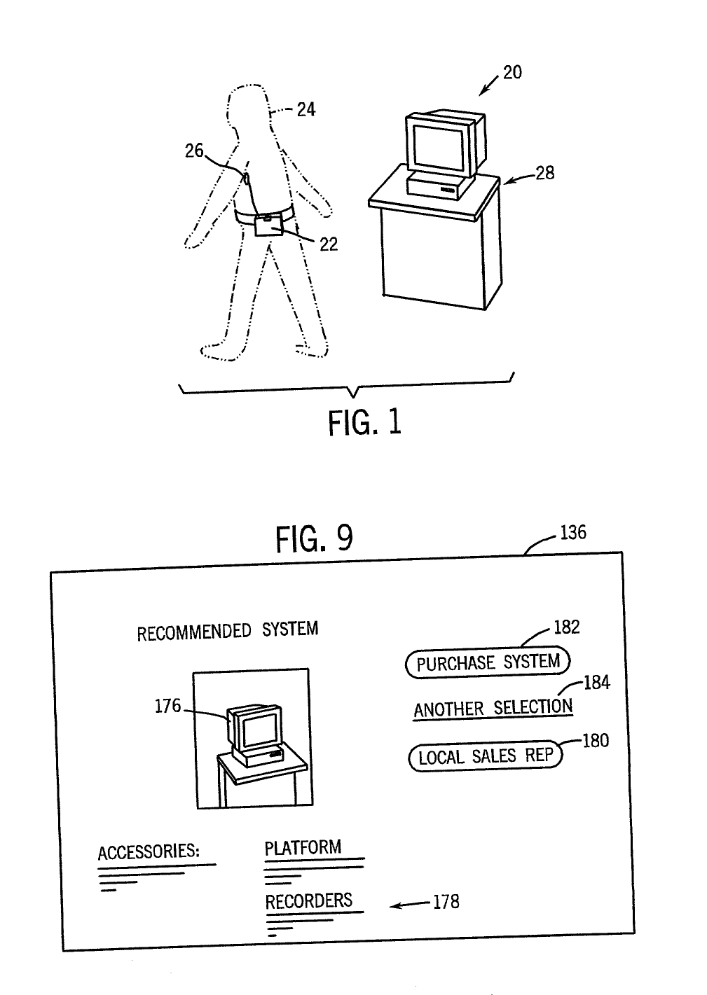

FIG. 1 illustrates an ambulatory monitoring (AM) system 20. To perform ambulatory monitoring, a cardiac recorder 22 is secured to a patient 24. The cardiac recorder 22 may have electrodes 26 that are placed at one or more locations on the patient's body. In operation, the cardiac recorder 22 may record heart activity periodically and/or have a manual operator that enables the patient to initiate cardiac recording when the patient experiences a cardiac event. After recording, the cardiac recorder 22 is brought to a computer system 28 that is used to retrieve the heart data recorded on the cardiac recorder 22 for analysis.

AM systems may be used in a variety of different clinical environments, such as large hospitals, small hospitals, clinics and private practices. Different AM systems may be used depending upon the clinical environment in which the AM system is to be used. Additionally, some AM systems are able to perform many tests per week while others are more suitable for performing a smaller number of tests per week. Some AM systems acquire data via digital recorders while others utilize tape recorders. Additionally, AM systems may incorporate a number of options, such as components, software, consumables, etc. Additionally, AM systems may store data in, for example, a data management system or separate electronic storage medium.

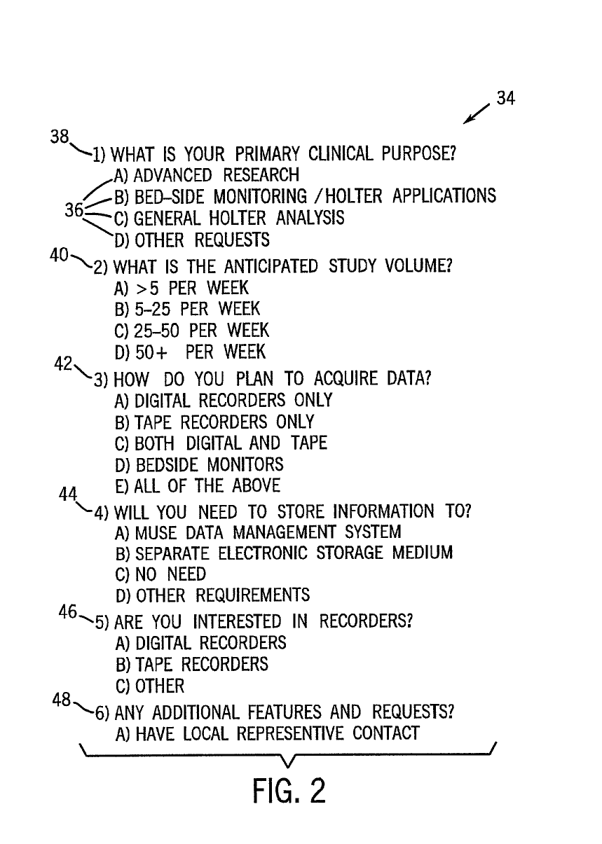

Referring generally to FIG. 2, an exemplary list 34 of questions that may be used to elicit information from an AM system customer is provided. The questions may be used to recommend a monitoring system that meets the customer's needs or at least provide information to serve as a basis for discussion between the supplier and the customer. Each answer to each question is shown with an associated letter identifier 36. The information obtained from the AM system customer's answers to the questions may be used to recommend an AM system to the customer. The questions and answers may vary from supplier to supplier depending on the AM systems the supplier provides to customers.

In the list of questions featured in FIG. 2, the first question 38 asks, “What is your primary clinical purpose?” which is followed by four answer choices: “A. Advanced Research”, “B. Bed-side Monitoring/Holter Applications”, “C. General Holter Analysis”, and “D. Other Requests.” The answer may be used to gage the customer's requirement for an AM system so that the supplier may recommend the most appropriate AM system for the customer. Additionally, the supplier may have separate sales groups for different clinical settings. In that situation, the customer's response to the first question 38 may be used during discussions between the customer and the supplier to determine the appropriate sales group to do business with the customer.

Primarily, the questions are designed to elicit information from the customer so that an AM system may be recommended to the customer. For example, the second question 40 asks, “What is the anticipated study volume?” The answer options for the second question 40 are: “A. >5 per week”, “B. 5 to 25 per week”, “C. 25 to 50 per week”, and “D. 50+ per week.” This information provides the supplier with the information needed to determine the appropriate size and capabilities of a basic AM system. An AM system that is only used to perform only a few resting patients each week need not be as robust an AM system as an AM for a customer that performs more than 50 examinations a week. This also gives an indication as to the price that a customer may be willing to pay for an AM system. The more frequently the customer may use the AM system, the more money they are probably willing to pay.

Similarly, the third question 42 asks the question “How do you plan to acquire data?” The answer choices for the third question 42 are: “A. Digital recorders only”, “B. Tape recorders only”, “C. Both digital and tape”, “Bedside monitors”, and “E. All of the above.” A system that cannot process the data in the format the customer desires to acquire data is not likely to be recommended to the customer.

Recommending an AM system may also encompass providing a customer with appropriate AM system options. The AM system options may be components, software, consumables, etc. The questions may be designed to elicit information from the customer to determine which, if any, AM system options the customer may need. For example, the fourth question 44 asks, “Will you need to store information to?” The answer choices for the fourth question 44 are “A. Muse data management system”, “B. Separate electronic storage medium”, “C. No need”, or “D. Other requirements.” The information obtained from the customer may enable the supplier to recommend optional components or software to enable the customer to store the information where desired.

Similarly, the fifth question 46 asks, “Are you interested in recorders?” The answer choices for the fifth question 46 are: “A. Digital recorders”, “B. Tape recorders”, and “C. Other.” This information enables the supplier to determine a recommended AM system and configure the system with the appropriate recorders. Additionally, an AM system that could not operate with the customer's desired recorders is not likely be recommended by a supplier to a customer.

Not every feature that the customer desires may be listed in the series of questions. Consequently, the sixth question 48 asks, “Any additional features and requests?” The answer directs the customer to contact a local representative if there are additional features desired by the customer.

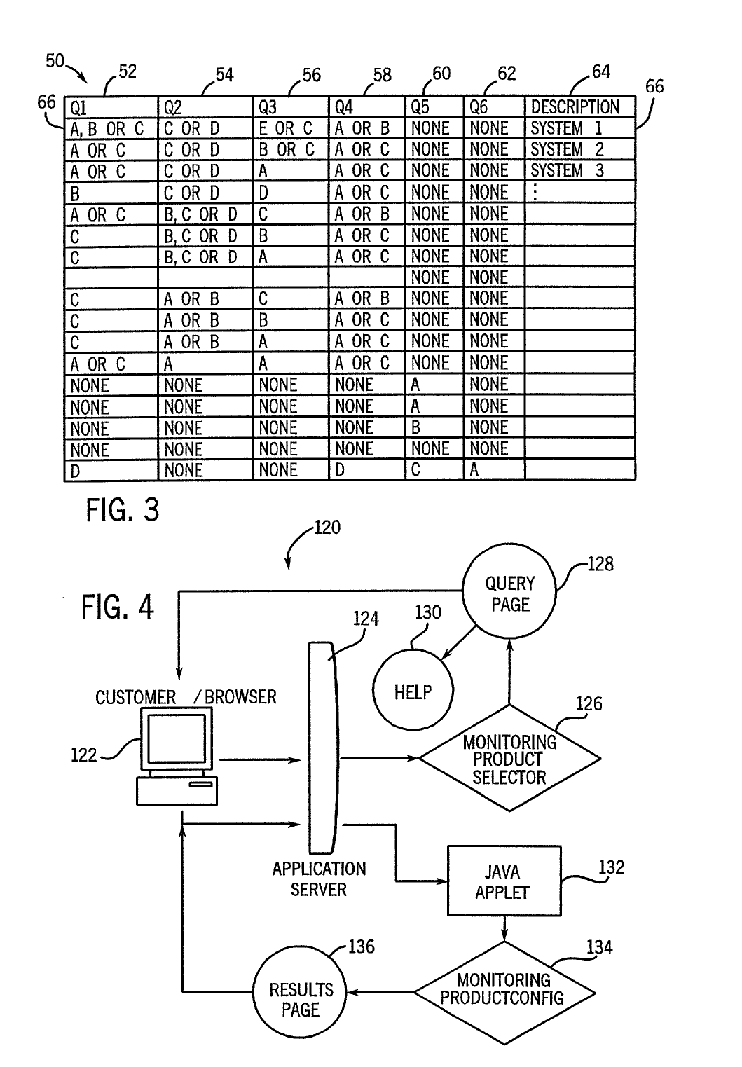

Referring generally to FIG. 3, an exemplary logic template 50 is provided. The logic template 50 correlates combinations of answers to the questions to AM systems. An AM system is recommended to the customer if the combination of answers provided by the customer correspond to a combination of answers in the template 50 that have an AM system associated with them.

In the illustrated embodiment, answers to each of the questions listed in FIG. 2 are shown in separate columns. Answers to the first question 38 are provided in a first column 52. Answers to the second question 40 are provided in a second column 54. Answers to the third question 42 are provided in a third column 56. Answers to the fourth question 44 are provided in a fourth column 58. Answers to the fifth question 46 are provided in a fifth column 60. Answers to the sixth question 48 are provided in a sixth column 62. Additionally, there is a column 64 for recommended AM systems.

Each row comprises the combination of answers to the questions that correspond to an AM system. For example, in the first row 66, the recommended AM system is identified as “SYSTEM 1.” SYSTEM 1 is recommended whenever the customer selects answers “A. Advanced Research”, “B. Bed-side Monitoring/Holter Applications” or “C. General Holter Analysis” to the first question 38 (What is your primary clinical purpose?); selects answers “C. 25-50 per week” or “D. 50+ per week” to the second question 40 (What is the anticipated study volume?); selects answer “E. All of the above” or “C. Both digital and tape” to the third question 42 (How do you plan to acquire data?); selects answer “A. Muse data management system” or “B. Separate electronic storage medium” to the fourth question 44 (Will you need to store information to?); and selects none of the answers to the fifth question 46 (Are you interested in recorders?) or the sixth question 48 (Any additional features and requests?). The rows following the first row 66 correspond to other combinations of answers that correspond to recommended AM systems.

Not every AM system supplied by a supplier may be one of the available recommended AM systems. The AM systems selected as recommended AM systems may be selected for a number of reasons, such as their popularity with customers based on previous sales, ease of configuration with options, etc. The supplier may not recommend a specific AM system if the combination of answers provided by the customer does not match any of the answers associated with a recommended AM system. Rather, the supplier may inform the customer to contact a sales representative to identify the best AM system for the customer's AM system needs.

Referring generally to FIG. 4, a system 120 is illustrated that enables an AM system supplier to provide a customer with a recommended AM system. In the illustrated embodiment, a customer may use a computer 122, or other browsing device to access the system 120 over a network, such as the Internet. The system 120 utilizes an application server 124, a Monitoring product selector file 126, a query page 128, a help page 130, a Java applet 132, a Monitoring product configuration file 134 and a results page 136 to provide a customer with a recommended AM system. The application server 124 is used to route information around system 120. The application server may comprise a program, such as a Java class. The Monitoring product selector file 126 holds the data that is used to populate the query page 128 to be supplied to the customer. The query page 128 contains the question designed to enable an AM system supplier to recommend an AM system to meet the customer's needs, or at least provide a basis for discussion between the supplier and the customer. The help page 130 is linked to the query page 128 and contains additional information designed to assist a customer in answering at least one of the questions.

The Java applet 132 forms part of the logic functions illustrated in FIG. 3. The Java applet 132 compares the answers in the completed query page 128 to data in the Monitoring product configuration file 134. The Monitoring product configuration file contains a set of data for a plurality of AM systems that correspond to predicted responses to the questions in the Monitoring product selector file. All possible combinations of answers to the plurality of questions may be provided with an associated, or recommended, AM system. Alternatively, not all of the possible combinations may be provided with a corresponding, or recommended, AM system. This smaller set of combinations may be based on a number of factors. For example, the Monitoring product configuration file 134 may be written so that a recommendation is made only for the most commonly sold configurations of AM systems. If the Java applet 132 finds a match between the customer's response and a predicted response, the AM system information corresponding to the predicted response is provided to the customer via the results page 136. If there is no match, an advisory message may be provided to the customer to direct the customer to contact a sales representative.

In the illustrated embodiment, the Monitoring product selector file 126 and the Monitoring product configuration file 134 are XML files. XML is a method for putting structured data in a text file. XML is powerful because it maintains the separation of the user interface from structured data. HTML specifies how to display data in a browser, but XML defines the content. For example, in HTML tags are used to tell the browser to display data as bold or italic. In XML, style sheets are employed to present the data in a browser. XML separates the data from the presentation and processing, enabling data to be displayed and processed differently by applying different style sheets and applications.

As will be appreciated by those skilled in the art, XML is a meta-markup language that provides a format for describing structured data. This facilitates more precise declarations of content and more meaningful search results across multiple platforms. An unlimited set of tags may be defined in XML. As noted above, while HTML tags may be used to display a word in bold or italic, for example, XML provides a framework for tagging structured data. An XML element can declare its associated data to be a price, a tax, a title, or any other desired data. As XML tags are adopted, there will be a corresponding ability to search for and manipulate data regardless of the applications within which it is found. Once data has been located, it can be delivered over a network and presented in a browser in any number of ways, or it can be handed off to other applications for further processing and viewing.

XML is a subset of the Standard Generalized Markup Language (SGML) that is optimized for delivery over the Web. XML provides a data standard that can encode the content, semantics, and schemata for a wide variety of cases ranging from simple to complex, and which may be used to markup the following: an ordinary document; a structured record, such as an appointment book or purchase order; an object with data and methods, such as the persistent form of a Java object; a data record, such as the result set of a query, meta content of a site; graphical presentations; standard schema entities and types; and all links between entities and types. Once the data is on the clients desktop it can be manipulated edited, and presented in multiple views, without return trips to the server. Servers may then become more scalable, due to lower computational and bandwidth loads. Also, because data is exchanged in the XML format, it can be easily merged from different sources. In the illustrated embodiment, the AM product selector file is an XML file. However, AM product selector file 126 may be composed of a different markup language, such as HTML.

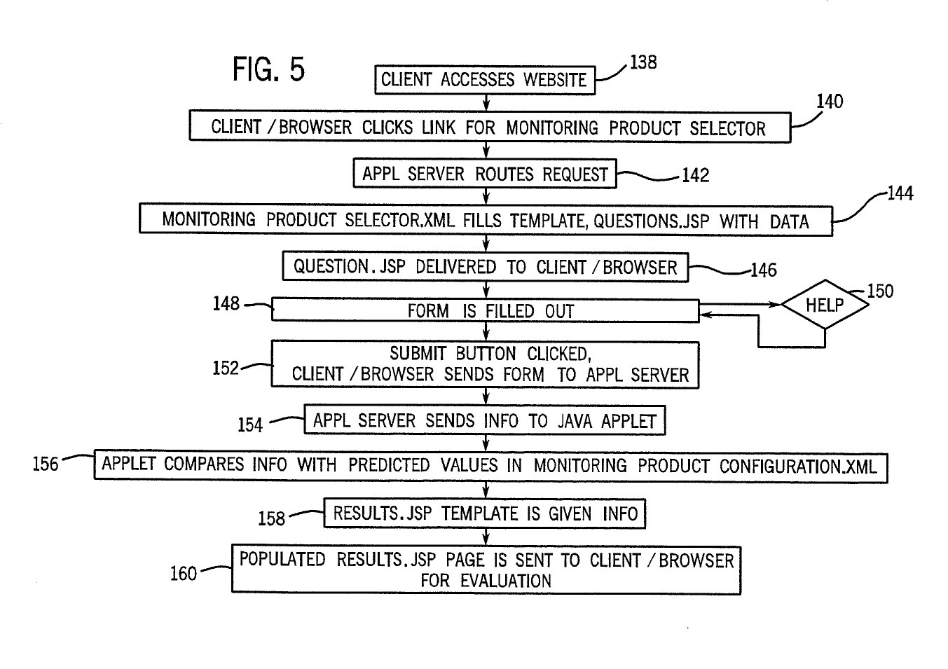

Referring generally to FIG. 5, an exemplary process by which a customer may be provided with information for a recommended AM system is illustrated. Initially, a customer or client accesses a site, as referenced by step 138. The site may provide an AM system supplier home page, an AM system specification page, a product selector page, or some other page of interest to a customer or client interested in purchasing a supplier's AM systems, AM system components, software, etc. Initially, the client or customer activates a link on the page to enter an AM system product selector, as referenced by step 140. An application server routes the request to enter the AM system product selector to a Monitoring System product selector file, as referenced by step 142. In an exemplary embodiment, the Monitoring product selector file is an XML file. The Monitoring System product selector file contains the data representing the questions to ask a customer to narrow the choice of an AM system, component, or software to a recommended AM system, component, or software. The Monitoring System product selector file fills the query page template with the data, e.g., questions, as referenced by step 144. In an exemplary embodiment, the query page is a Java script file. The query page is sent to the customer browser for completion, as referenced by step 146.

The customer then completes the query page, as referenced by step 148. If a customer would like additional information to help in choosing an answer, the client may activate a link to a help file, as referenced by step 150. When the link is activated, a help page 130 is presented to the customer. In this embodiment, the help page 130 provides additional information specific to each question on the query page. The additional information is designed to assist the customer answer the questions. After obtaining the information, the customer may then return to the query page and continue answering questions. When the customer has completed answering the questions they may send the completed query page back to the application server by activating a virtual button on the query page, as referenced by step 152.

In the exemplary process, the application server couples the completed query page 128 to a Java applet 132, as referenced by step 154. The Java applet 132 compares the information provided by the customer in their answers to the questions in the query page to predicted responses to the questions contained within the Monitoring product configuration file 134, as referenced by step 156. If a match is found between the customer's response to the questions and the predicted responses to the questions, the results page 136 is filled with data describing the recommended AM system, component, or software, that corresponds to the predicted responses to the questions, as referenced by step 158. The results page 136 is then provided to the customer for viewing and/or evaluation, as referenced by step 160.

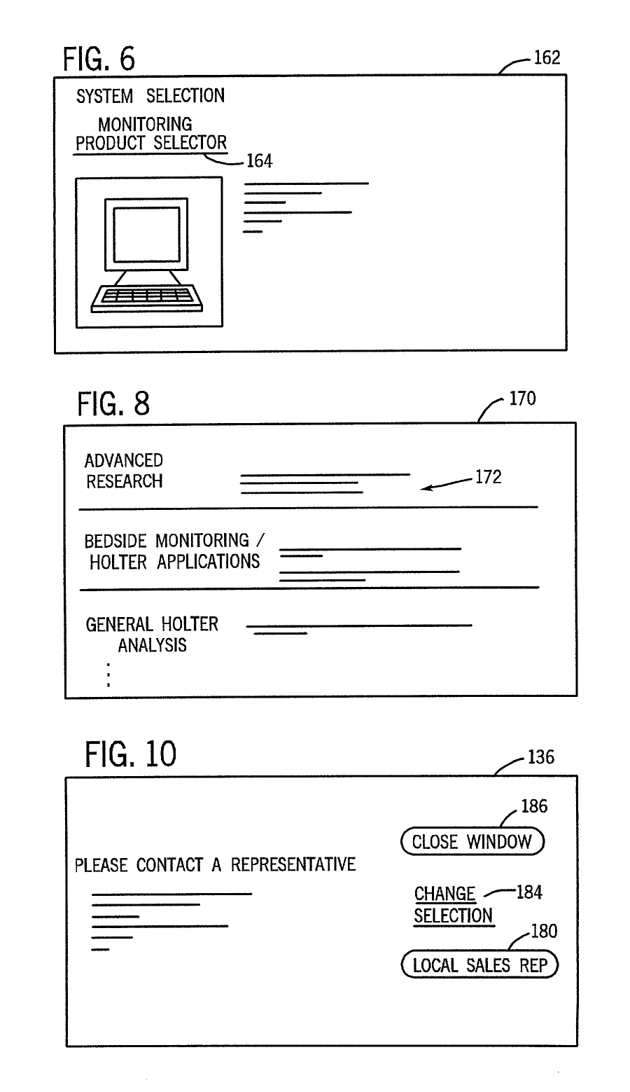

Referring generally to FIG. 6, a page 162 for an AM system supplier is illustrated. The page 162 may contain information about the suppliers AM systems, components or software. In addition, the page 162 also contains a link 164 to an AM product selector.

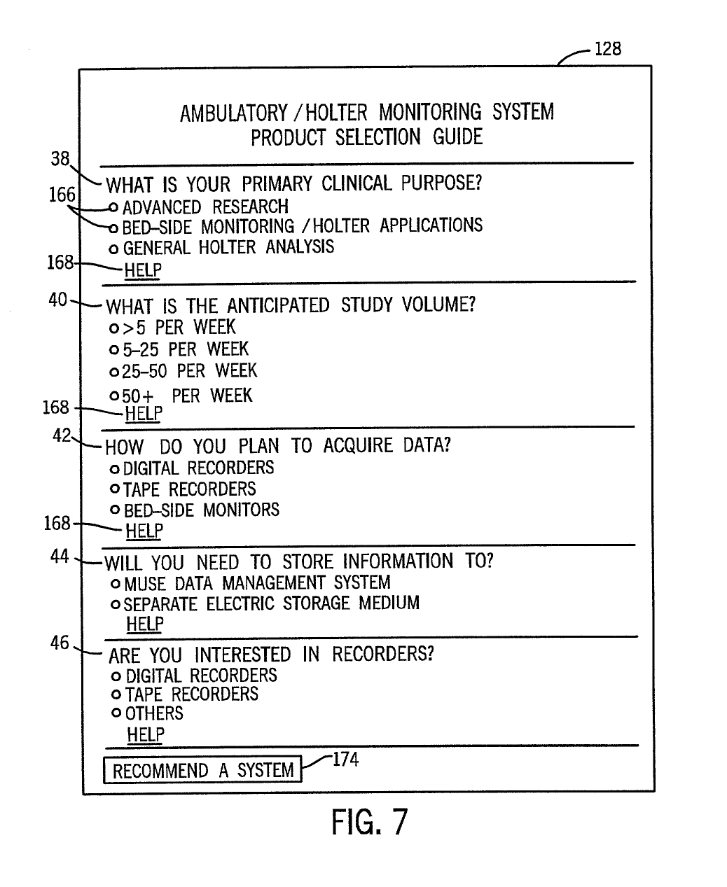

Referring generally to FIG. 7, when a customer activates the link 164, system 120 operates to provide the customer browser 122 with a query page 128. In the illustrated embodiment, the page presents the series of questions illustrated in FIG. 2 to the customer. Each question is answered by selecting one or more of the choice registers 184. Some questions may have mutually exclusive answers while others may allow multiple answers. The choice registers 184 may be selected by placing the cursor over a choice register 184 and clicking with a mouse button.

In addition, each question may have a link 168 to the help file 130. When the link is activated a small browser window 170 is opened, as best illustrated in FIG. 8. In the illustrated embodiment, the link 168 after the question, “What is your clinical purpose?” has been activated. Help window 170 contains text 172 describing the various clinical purpose. However, help window 172 and help file 130 may be populated with any type of information that may be designed to assist a customer in answering any of the questions provided to the customer.

Referring again to FIG. 7, when the customer has made their selections, a virtual button 174 is activated. Activating the virtual button 174 directs the query page to be returned to the system 120 and directs the system 120 to provide the customer with a recommended AM system, component or software.

Referring generally to FIG. 9, system 120 provides the recommendation for an AM system, component, and/or software on a results page 136. The results page 136 provides the customer with a recommended system 176 and recommended options 178. Additionally, results page 136 may have a virtual button 180 that is operable to activate a program to identify a supplier sales representative located near the customer. The results page 136 may also have a purchasing link 182 to initiate a purchasing program to enable a customer purchase an AM system, component, and/or software. The results page 136 may also have a link 184 to enable a customer perform another product selection with the AM product selector.

As best illustrated in FIG. 10, if there is no AM system, component, or software that matches the customer's responses to the questions the results page 136 may inform the customer that no AM system, component, or software may be recommended based on the customer's responses to the questions. The customer may be informed to contact an AM system supplier's sales representative. Therefore, this embodiment of results page 136 also may have a virtual button 180 that is operable to activate a program to identify the supplier's sales representative nearest to the customer. The results page 136 also may have a virtual button 186 to close the browser to close the product selector.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A computer system coupled to a network to enable an ambulatory monitoring (AM) system supplier to provide a customer with information for a recommended AM system, the computer system comprising:
an application server to direct a query page to the customer via the network, the query page comprising a plurality of questions and a plurality of answer choices for each question, wherein the plurality of questions are designed to establish whether at least one of a plurality of AM systems is suitable as a possible AM system for the customer, further wherein at least one of the plurality of questions establishes the type of data recorder to be used with the AM system;
a comparison program to receive the customer's answer choices and compare the customer's answer choices to a plurality of predicted answer choices, each of the plurality of predicted answer choices corresponding to a specific AM system; and
a server to provide a results page to the customer via the network, the results page providing the customer with the specific AM system as a recommended AM system if the customer's answer choices match the predicted answer choices corresponding to the specific AM system.

2. The system as recited in claim 1, wherein at least one of the plurality of questions is designed to determine the amount of usage that the AM system may be used in a defined time period.

3. The system as recited in claim 1, wherein at least one of the plurality of questions is designed to determine the customer's purpose for using the AM system.

4. The system as recited in claim 1, wherein at least one of the questions is designed to establish the type of data recorder the customer may use with the AM system.

5. The system as recited in claim 1, wherein at least one of the questions is designed to establish the AM system recording medium.

6. The system as recited in claim 1, wherein at least one of the plurality of questions is designed to identify to the supplier the specific sales entity within the supplier in which to direct the customer to conduct business with the supplier.

7. The system as recited in claim 1, wherein the application server comprises a Java class.

8. The system as recited in claim 1, wherein the comparison program comprises a Java applet.

9. The system as recited in claim 1, wherein the plurality of predicted answer choices and the corresponding specific AM systems are stored in a product selector file.

10. The system as recited in claim 9, wherein the product selector file is written in extensible markup language (XML).

11. The system as recited in claim 1, wherein the query page is written in Java script.

12. The system as recited in claim 1, wherein the query page comprises a link to a help page, wherein the help page provides information to assist a customer answer at least one of the plurality of questions.

13. The system as recited in claim 1, wherein each question has an associated link to a help page, wherein the help page provides information to assist a customer answer each of the plurality of questions.

14. The system as recited in claim 1, wherein specification information for each of the specific AM systems are stored in a product configuration file.

15. The system as recited in claim 14, wherein a specific configuration of an AM system comprises a software package.

16. The system as recited in claim 14, wherein the product selector file is written in extensible markup language (XML).

17. The system as recited in claim 13, wherein the product selector file populates the results page with a specific AM system configuration that matches the customer's responses in the completed query page.

18. The system as recited in claim 1, wherein the results page is written in Java script.

19. A computer system coupled to a network to enable an ambulatory monitoring (AM) system supplier provide a customer with a recommended AM system via the network, the computer system comprising:
an application server coupled to a network, the application server directing a customer to files stored in the computer system;
a product selector file written in a markup language and stored in the computer system, the product selector file defining a plurality of questions designed to elicit data from a customer to determine a AM system to recommend to the customer from among a plurality of AM systems, wherein the product selector file provides the plurality of questions to a query page for delivery to a customer;
a program that operates to determine an AM system to recommend to the customer by comparing data provided by the customer via the plurality of questions to AM system data stored in the computer system; and
a product configuration file written in a markup language and stored in the computer system, the product configuration file holding the AM system data used by the program, wherein the product configuration file provides information relating to a recommended AM system to a results page for delivery to the customer.

20. The system as recited in claim 19, wherein at least one of the plurality of questions is designed to determine whether the customer's clinical purpose for using the AM system.

21. The system as recited in claim 19, wherein at least one of the plurality of questions is designed to determine the customer's expected volume of use of the AM system.

22. The system as recited in claim 19, wherein at least one of the plurality of questions is designed to determine the customer's expected method of data collection.

23. The system as recited in claim 19, wherein at least one of the questions is designed to determine the customer's expected means of AM system data storage.

24. The system as recited in claim 19, wherein at least one of the plurality of questions is designed to identify to a representative of the supplier's a specific sales entity of the supplier's to which sales inquiries are to be directed.

25. The system as recited in claim 19, wherein the product selector file is written in extensible markup language (XML).

26. The system as recited in claim 19, wherein the product configuration file is written in extensible markup language (XML).

27. The system as recited in claim 19, wherein each question is a multiple-choice question.

28. The system as recited in claim 19, further comprising a help file written in a markup language and containing information regarding each choice in at least one multiple-choice question.

29. The system as recited in claim 28, wherein the help file is written in hypertext markup language (HTML).

30. The system as recited in claim 19, wherein the application server is a Java class.

31. The system as recited in claim 19, wherein the program is a Java applet.

32. The system as recited in claim 19, wherein the query page is written in a Java script language.

33. The system as recited in claim 19, wherein the results page is written in a Java script language.

34. The system as recited in claim 15, wherein a recommended computer system comprises software.

35. A method of utilizing a computer system coupled to a network to assist a customer to configure an ambulatory monitoring (AM) system from among a plurality of AM systems, components and software, the method comprising the acts of:
routing a request for assistance from a customer to a product selector file written in extensible markup language (XML), wherein the product selector file fills a template with questions stored in the product selector file;
delivering the template over the network to a customer;
receiving a completed tem plate from the customer; and
determining a recommended AM system configuration by comparing customer data derived from the completed template to supplier data stored in the computer system in a product configuration file written in XML, wherein the product configuration file fills a results page with the recommended AM system configuration for delivery to the customer over the network.

36. The method as recited in claim 35, wherein routing comprises activating a link in a page to an application server.

37. The method as recited in claim 36, wherein the application server routes the request to the product selector file.

38. The method as recited in claim 35, wherein the template is a Java script file.

39. The method as recited in claim 35, wherein the results page is a Java script file.

40. A method of utilizing a computer system to configure a recommended ambulatory monitoring (AM) system from among a plurality of AM systems, components and software, the method comprising the acts of:
connecting a customer communication system to a computer system provided by a AM system supplier;
routing a request for assistance from the customer to a product selector file written in extensible markup language (XML), wherein the product selector file fills a template with questions stored in the product selector file;
delivering the template to a customer;
completing the template with the customer communication system and transmitting it to the computer system;
receiving a completed template from the customer; and
determining a recommended AM system and configuration by comparing customer data derived from the completed template to supplier data stored in the computer system in a product configuration file written in XML, wherein the product configuration file fills a results page with the recommended AM system configuration for delivery to the customer communication system.

41. The method as recited in claim 40, wherein the customer communication system is a second computer system having an interface coupled to the Internet.

42. The method as recited in claim 40, wherein the supplier data comprises data for a plurality of AM system configurations of components and software.

43. The method as recited in claim 40, wherein determining comprises using a program to compare the customer data to the plurality of AM system configurations of components and software.

44. The method as recited in claim as recited in claim 40, wherein the product configuration file provides the results page with the data for a specific AM system configuration of components and software when the program identifies a specific AM system configuration that matches the customer data.
